(19) United States
(12) Patent Application Publication
(10) Pub. No.: US 2019/0021142 A1
(43) Pub. Date: Jan. 17, 2019

(54) INDUCTION HEATING COOKER AND GRILL TRAY

(71) Applicant: Panasonic Intellectual Property Management Co., Ltd., Osaka (JP)

(72) Inventors: ISAO MIZUTA, Shiga (JP); TAIHEI OGURI, Shiga (JP); TAKAYUKI AKASHI, Nara (JP); SHINICHI YAMANE, Osaka (JP)

(21) Appl. No.: 16/069,883

(22) PCT Filed: Feb. 10, 2017
(86) PCT No.: PCT/JP2017/004856

§ 371 Date: Jul. 12, 2018

(30) Foreign Application Priority Data
Feb. 25, 2016 (JP) 2016-034621
Sep. 29, 2016 (JP) 2016-192073

(51) Int. Cl. H05B 6/12; A47J 37/06

(52) U.S. Cl. CPC H05B 6/129; A47J 37/0635

(57) ABSTRACT

Provided is an induction heating cooker which can be carried to a desired position on a cooking table to conduct grill cooking using induction heating and radiation heating and includes a grill tray (8) that is placed inside a heating chamber (7) and includes an engaging section that is used for removing the grill tray (8) from the heating chamber (7) and inserting the grill tray (8) into the heating chamber (7). The grill tray (8) is configured as being placeable on a cooking table. Grill cooking is conducted using an upper heating unit which is provided above the heating chamber (7) and heats a food item inside the heating chamber (7) by radiation and a lower heating unit which is provided below the heating chamber and heats the grill tray by induction.

### TECHNICAL FIELD

The present disclosure relates to an induction heating cooker for grill cooking in which, for example, meat, fish, or vegetables are grilled, and particularly relates to an induction heating cooker which is portable and usable at different cooking locations and a grill tray used in the induction heating cooker.

### DESCRIPTION OF THE RELATED ART

In the case of grill cooking in which a food item is directly heated by heat from a heat source, for example, when grilling meat, fish, or vegetables, a heating source (for example, a gas cooking stove or an electric cooking stove) installed in a home or commercial kitchen usually heats a griddle, a wire mesh, a frying pan, or the like to conduct cooking. Other examples of a cooking device for grilling meat, fish, and the like include a roaster oven installed in a kitchen. In order to prevent generation of smoke due to oil from an item to be heated falling on the heat source, the roaster oven is configured to grill the item to be heated by radiation heat applied from above and the side.

As mentioned above, in general, a heat source such as a stove installed in a home or commercial kitchen is used for grill cooking and therefore, the cooking is conducted at a predetermined fixed location. In the grill cooking, a heating device such as a griddle, a wire mesh, a frying pan, or the like is used on the heat source; temperature management and heating time adjustment for the heating device to grill a food item to desired doneness are very difficult and rely on cook's experience and instinct.

However, in the case of using the roaster oven which is a cooking device installed in a kitchen, temperature management and heating time adjustment for a grill tray can be set in advance, and thus it is possible to achieve preferred doneness to some extent (refer to Patent Literatures (PTLs) 1 and 2).

However, a roaster oven such as those proposed in PTLs 1 and 2 is a cooking device incorporated in an induction heating cooker installed in a home or commercial kitchen and thus is not portable. Therefore, grill cooking needs to be conducted at the location where the induction heating cooker is installed; the cooking location for grill cooking is restricted. Furthermore, since the roaster oven is incorporated as a part of the induction heating cooker installed in a home or commercial kitchen, a limited occupancy space is available to provide the roaster oven, resulting in a small heating area. Thus, for example, it is difficult to grill a large food item such as a pizza.

### CITATION LIST

### Patent Literature

PTL 1: Unexamined Japanese Patent Publication No. 2010-267422

PTL 2: Unexamined Japanese Patent Publication No. 2014-203635

### SUMMARY

An object of the present disclosure is to provide an induction heating cooker which is not only capable of easily conducting grill cooking in which a food item is grilled to desired doneness, but also capable of grill cooking at a desired location, and a grill tray used in the induction heating cooker.

Specifically, the present disclosure provides an induction heating cooker which is configured to conduct grill cooking using at least induction heating and can, for example, be carried to a desired position on a cooking table to conduct the grill cooking, and a grill tray used in the induction heating cooker.

An induction heating cooker according to an aspect of the present disclosure includes: a heating chamber in which an item to be heated is housed; a door which seals an opening through which the item to be heated is inserted into and removed from the heating chamber; a heating unit having a configuration which heats, by induction, the item to be heated that is housed inside the heating chamber; a control unit which drives and controls the heating unit; and a setting unit which sets a heating operation of the heating unit. The induction heating cooker is configured as being placeable on a table.

A grill tray according to an aspect of the present disclosure is used in an induction heating cooker which is configured as being placeable on a table and includes: a heating chamber in which an item to be heated is housed; a door which seals an opening through which the item to be heated is inserted into and removed from the heating chamber; and a heating unit having a configuration which heats, by induction, the item to be heated that is housed inside the heating chamber. The grill tray is formed of a high thermal conductive material and includes a magnetic material in a region opposite the heating unit.

### BRIEF DESCRIPTION OF THE DRAWINGS

FIG. 1 is a perspective view illustrating the external appearance of an induction heating cooker according to Embodiment 1 of the present disclosure.

FIG. 2 is a perspective view illustrating an induction heating cooker according to Embodiment 1 with a door open.

FIG. 3 is a perspective view illustrating an induction heating cooker according to Embodiment 1 with a half of a grill tray taken out of a heating chamber.

FIG. 4 is a perspective view illustrating an induction heating cooker according to Embodiment 1 with a grill tray taken out of a heating chamber and placed on a table.

FIG. 5 is an exploded perspective view of a main body of an induction heating cooker according to Embodiment 1.

FIG. 6 is a perspective view of an induction heating cooker according to Embodiment 1 with a main body cover removed.

FIG. 7 is a cross-sectional view of an induction heating cooker according to Embodiment 1 when viewed from the side.

FIG. 8 is a perspective view illustrating a grill tray used in an induction heating cooker according to Embodiment 1.

FIG. 9 is a plan view illustrating a grill tray used in an induction heating cooker according to Embodiment 1.

FIG. 10 is a cross-sectional view of the grill tray in FIG. 9 taken along line 10-10.

FIG. 11 is a bottom view of a grill tray used in an induction heating cooker according to Embodiment 1.

FIG. 12 is a cross-sectional view of the grill tray in FIG. 9 taken along line 12-12.

FIG. 13 is a side view of a grill tray used in an induction heating cooker according to Embodiment 1.

FIG. 14 is a cross-sectional view of an induction heating cooker according to Embodiment 1 when viewed from the side in the state where a grill tray is placed in a cooking position inside a heating chamber.

FIG. 15 is a cross-sectional view of an induction heating cooker according to Embodiment 1 when viewed from the side in the state where a grill tray is placed in an intermediate holding position as a result of being pulled out from a heating chamber.

FIG. 16 is a perspective view illustrating an inner configuration of a main body of an induction heating cooker according to Embodiment 1 in the state where a grill tray is placed in an intermediate holding position.

FIG. 17 is a side view of an induction heating cooker according to Embodiment 1 with a main body cover removed.

FIG. 18 is a perspective view illustrating a configuration of a cooling fan in an induction heating cooker according to Embodiment 1.

FIG. 19 is a back view of a cooling fan in an induction heating cooker according to Embodiment 1.

FIG. 20 is a left-hand side view of a cooling fan in an induction heating cooker according to Embodiment 1.

FIG. 21 is a perspective view of an induction heating cooker according to Embodiment 1 when viewed from the top right of a rear area on the back side.

FIG. 22 is a perspective view of an induction heating cooker according to Embodiment 1 when viewed from the bottom left of a rear area on the back side.

FIG. 23 illustrates the back surface of an induction heating cooker according to Embodiment 1.

FIG. 24 is a perspective view illustrating a grill tray used in an induction heating cooker according to Embodiment 2 of the present disclosure.

FIG. 25 is a plan view illustrating a grill tray used in an induction heating cooker according to Embodiment 2.

FIG. 26 is a cross-sectional view of the grill tray in FIG. 25 taken along line 26-26.

FIG. 27 is a bottom view of a grill tray used in an induction heating cooker according to Embodiment 2.

FIG. 28 is a cross-sectional view of the grill tray in FIG. 25 taken along line 28-28.

FIG. 29 is a side view of a grill tray used in an induction heating cooker according to Embodiment 2.

FIG. 30 is an expanded view of an edge section of a lower surface of a foot portion of the grill tray illustrated in the bottom view in FIG. 27.

FIG. 31 is a cross-sectional side view of an induction heating cooker according to Embodiment 2 in the state where a grill tray is placed in a cooking position inside a heating chamber.

FIG. 32 is a cross-sectional side view of an induction heating cooker according to Embodiment 2 in the state where a grill tray is in the process of being pulled out from a heating chamber.

FIG. 33 is an expanded view illustrating the grill tray in the process of being pulled out, which is illustrated in FIG. 32, and a sliding projection and an attitude-holding projection which contact the grill tray.

FIG. 34 is an expanded cross-sectional view illustrating a sliding projection which slides on a sliding portion of the grill tray in the process of being pulled out, which is illustrated in FIG. 32.

FIG. 35 is a cross-sectional side view of an induction heating cooker according to Embodiment 2 in the state where a grill tray is placed in an intermediate holding position as a result of being pulled out from a heating chamber.

### DETAILED DESCRIPTION

An induction heating cooker according to the first aspect of the present disclosure includes: a heating chamber in which an item to be heated is housed; a door which seals an opening through which the item to be heated is inserted into and removed from the heating chamber; a heating unit including an induction heating unit which heats, by induction, the item to be heated that is housed inside the heating chamber; a control unit which drives and controls the heating unit; and a setting unit which sets a heating operation of the heating unit. The induction heating cooker is configured as being placeable on a table.

The configuration of the induction heating cooker according to the first aspect of the present disclosure makes it possible to easily conduct grill cooking in which a food item is grilled to desired doneness, and allows a user to conduct the grill cooking at a desired location. Furthermore, when the food item is heated by induction, efficient cooking with heat is possible, and thus cooking time can be reduced.

In the induction heating cooker according to the second aspect of the present disclosure, the heating unit according to the first aspect may further include a radiation heating unit which heats an interior of the heating chamber by radiation.

With such a configuration, it is possible to easily conduct grill cooking in which a food item is grilled to desired doneness.

In the induction heating cooker according to the third aspect of the present disclosure, the heating unit according to the second aspect may include the induction heating unit below the heating chamber and the radiation heating unit above the heating chamber.

With such a configuration, a food item can be heated to desired doneness by radiation from above the heating chamber while the item to be heated is efficiently heated by induction from below the heating chamber.

In the induction heating cooker according to the fourth aspect of the present disclosure, the heating unit according to one of the first to third aspects is configured to heat a grill tray as the item to be heated, and the heating chamber includes a heating chamber projection which positions the grill tray in a cooking position inside the heating chamber.

With such a configuration, the cooking position for cooking with heat in which the grill tray is housed inside the heating chamber is defined, and thus the grill tray and the lower heating unit disposed under the bottom surface of the heating chamber reliably oppose each other, allowing prevention of uneven doneness or the like of the food item.

In the induction heating cooker according to the fifth aspect of the present disclosure, when the grill tray according to any one of the first to fourth aspects is housed in the heating chamber and positioned in the cooking position, a foot portion of the grill tray that projects downward may be located in a recess formed on a bottom surface of the heating chamber and does not contact the bottom surface, and a cooking surface of the grill tray on which a food item is placed may be located in a predetermined position with respect to the heating unit.

With such a configuration, the grill tray is disposed in the predetermined position with respect to the heating unit, and thus the positional relationship between the grill tray and the heating unit is determined, resulting in accurate heating of the food item.

In the induction heating cooker according to the sixth aspect of the present disclosure, the grill tray according to any one of the first to fifth aspects may be configured to be supported on the door in an open state by locking with the heating chamber projection when the grill tray is being pulled out from the heating chamber.

Such a configuration allows a user to easily and safely take the grill tray out of the heating chamber.

A grill tray according to the seventh aspect of the present disclosure is used in an induction heating cooker which is configured as being placeable on a table and includes: a heating chamber in which an item to be heated is housed; a door which seals an opening through which the item to be heated is inserted into and removed from the heating chamber; and a heating unit including an induction heating unit which heats, by induction, the item to be heated that is housed inside the heating chamber. The grill tray is formed of a high thermal conductive material and includes a magnetic material in a region opposite the heating unit.

With such a configuration, the grill tray is a small load for an inverter circuit and the lower heating unit, and since the magnetic material is formed in the region opposite the heating unit, the grill tray is efficiently heated by induction.

As the grill tray according to the eighth aspect of the present disclosure, the grill tray according to the seventh aspect may include a water storage region configured to be able to hold water.

With such a configuration, the effect of steaming a food item can be produced using the water stored in the water storage region.

As the grill tray according to the ninth aspect of the present disclosure, a cooking surface of the grill tray according to the seventh or eighth aspect on which a food item is placed may include a boundary mark indicating a region that opposes the heating unit, and a higher-temperature cooking region and a lower-temperature cooking region of the cooking surface may be separated by the boundary mark.

With such a configuration, a food item to be cooked at high temperature, for example, meat, fish, etc., can be placed in the high-temperature cooking region located inward of the boundary mark and be cooked with heat, and a food item to be cooked at low temperature, for example, vegetables, etc., can be placed in the low-temperature cooking region located outward of the boundary mark and be cooked with heat. Thus, a user can easily and reliably conduct desired cooking with heat.

As the grill tray according to the tenth aspect of the present disclosure, the grill tray according to any one of the seventh to ninth aspects may be configured to include a foot portion formed of a heat-resistant resin material and when the grill tray is taken out of the heating chamber and placed on the table, support the grill tray with a predetermined space above a placement surface of the table.

With such a configuration, it is possible to suppress the effect heat from the grill tray has on the placement surface of the table on which the grill tray is placed.

As the grill tray according to the eleventh aspect of the present disclosure, the cooking surface of the grill tray according to any one of the seventh to tenth aspects on which the food item is placed may be in the form of waves and coated by a non-sticky resin.

With such a configuration, dirt such as oil and grease spattered during cooking and remaining debris after cooking can be prevented from sticking to the grill tray, and even if such dirt sticks thereto, the dirt can be easily wiped out.

Hereinafter, as exemplary embodiments of an induction heating cooker according to the present disclosure, examples of an induction heating cooker which conducts grill cooking using induction heating (IH) and radiation heating in combination will be described with reference to the attached drawings.

Note that the configuration of the induction heating cooker according to the present disclosure is not limited to the configurations of the induction heating cookers stated in the following exemplary embodiments and includes the configuration of an equivalent induction heating cooker with the technical idea described in the following exemplary embodiments. For example, the induction heating cooker according to the present disclosure is applicable to a configuration in which grill cooking is conducted without radiation heating but only by induction heating (IH).

The exemplary embodiments described below each illustrate one example of the present disclosure; the configurations, functions, operations, and the like described in the exemplary embodiments are mere examples, and therefore do not limit the present disclosure.

Among the structural elements in the following exemplary embodiments, structural elements not recited in the independent claims indicating the broadest concept are described as arbitrary structural elements.

Furthermore, elements in the exemplary embodiments can be combined, and an exemplary embodiment resulting from such combination produces the advantageous effects of each element.

Note that the grill cooking in the present description refers to a cooking method in which a food item which is an item to be heated is directly heated by the heat from a heat source, meaning cooking with heat using a gridiron, an iron grate or stick (iron skewer), a metal plate, or the like to grill the item to be heated.

In the description of the exemplary embodiments below, a horizontal direction indicates a direction viewed from a user using the induction heating cooker, and the user side of the induction heating cooker is referred to as the front/forward (the front side) while the side opposite the user side is referred to as the rear/rearward (the back side). The left and the right in the description of the exemplary embodiments indicate the left-hand side and the right-hand side, respectively, when viewed from the front side of the induction heating cooker.

### Embodiment 1

Hereinafter, an induction heating cooker and a grill tray used in the induction heating cooker according to Embodiment 1 of the present disclosure will be described with reference to the attached drawings.

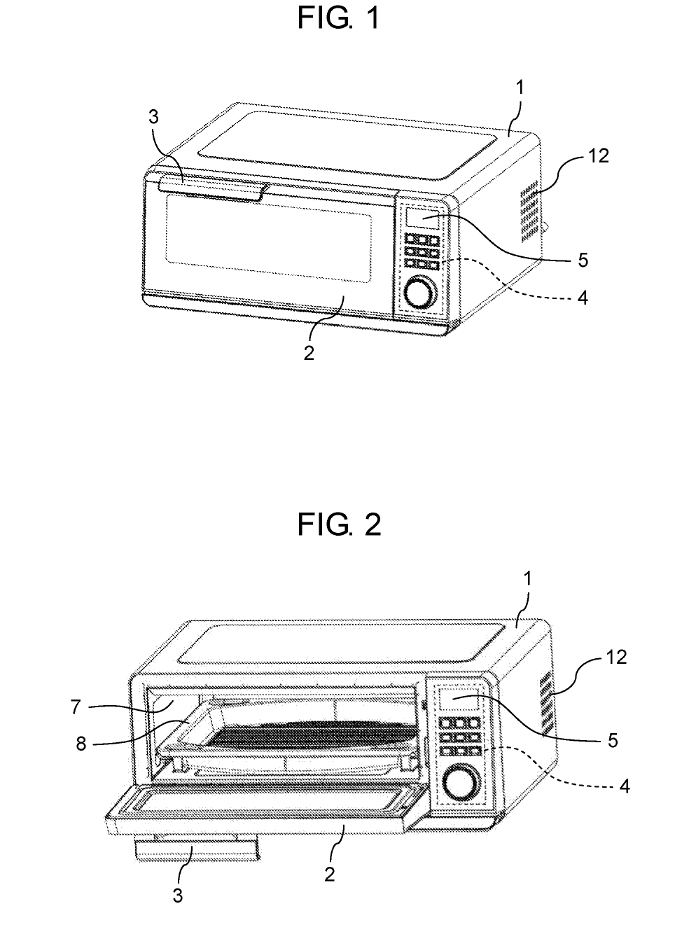

FIG. 1 is a perspective view illustrating the external appearance of the induction heating cooker according to Embodiment 1 of the present disclosure. FIG. 2 is a perspective view illustrating the induction heating cooker in FIG. 1 according to Embodiment 1 with a door open.

As illustrated in FIG. 1 and FIG. 2, the induction heating cooker is configured such that a front opening of heating chamber 7 provided inside main body 1 can be opened and closed by door 2. Door handle 3 is provided on an upper end section of door 2, and when a user grabs door handle 3 and opens door 2 from above by rotating door 2, the front opening of heating chamber 7 is opened upward. Closing door 2 practically seals the interior of heating chamber 7, and a food item which is an item to be heated placed inside heating chamber 7 is heated in the practically sealed state and thus placed in the state where grill cooking is conducted.

A food item that is placed inside heating chamber 7 is placed on grill tray 8 and cooked with heat (grilled). Positioning mechanisms to be described later are provided on grill tray 8 and an inner wall surface of heating chamber 7 so that grill tray 8 is reliably placed in a predetermined position on a flat bottom surface of heating chamber 7.

The front of the induction heating cooker includes, in addition to upwardly-opening door 2, setting unit 4 for a user to set various cooking conditions such as a cooking temperature and cooking time for cooking with heat. Setting unit 4 provided on the front of the induction heating cooker includes display unit 5 which displays the various cooking conditions, the heating state during cooking with heat, etc. In the configuration according to Embodiment 1, setting unit 4 is placed to the right of door 2 from the users' viewpoint.

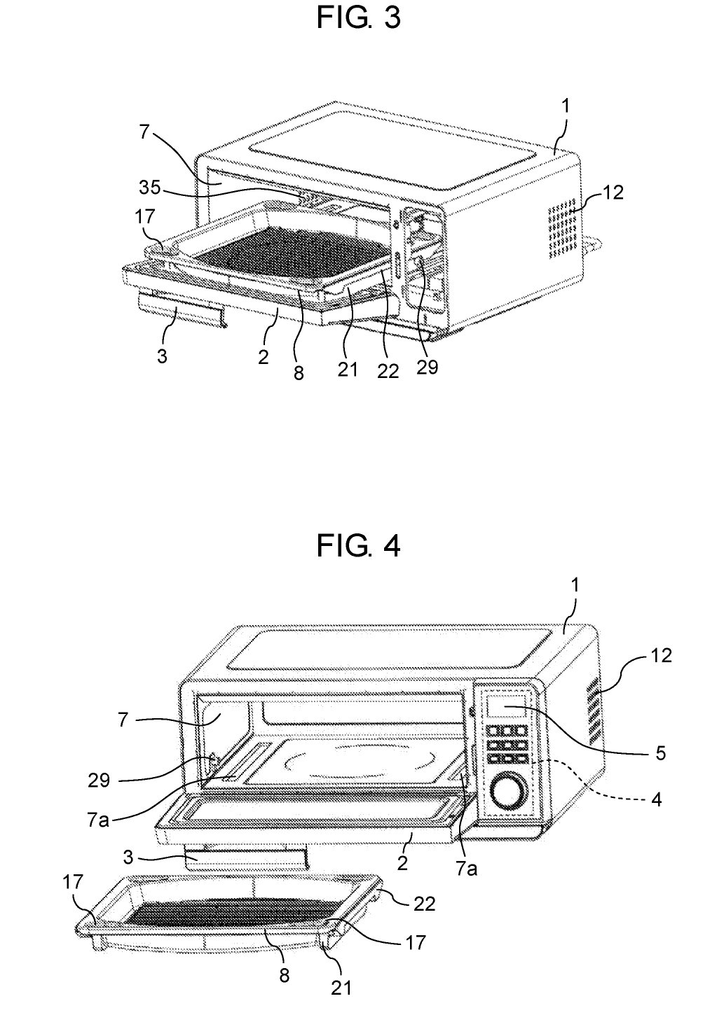

FIG. 3 is a perspective view illustrating the state in an intermediate holding position where a half of grill tray 8 is outside heating chamber 7. FIG. 3 illustrates the state where setting unit 4 is removed in order to illustrate the locking state of grill tray 8 to be described later. FIG. 4 illustrates the state where grill tray 8 is placed on a table, for example, on a cooking table, as a result of being taken out of heating chamber 7. In the configuration according to Embodiment 1, the heating space of heating chamber 7 has the shape of a substantial cuboid greater in lateral length (which is the width of the front opening) than depth. One example of a specific shape of the heating space of heating chamber 7 is 350 mm (wide)×330 mm (deep)×110 mm (high). Grill tray 8 is in the shape of a rectangle corresponding to the shape of the bottom surface of the heating space of heating chamber 7 and is in the form of a tray with its entire peripheral edge raised.

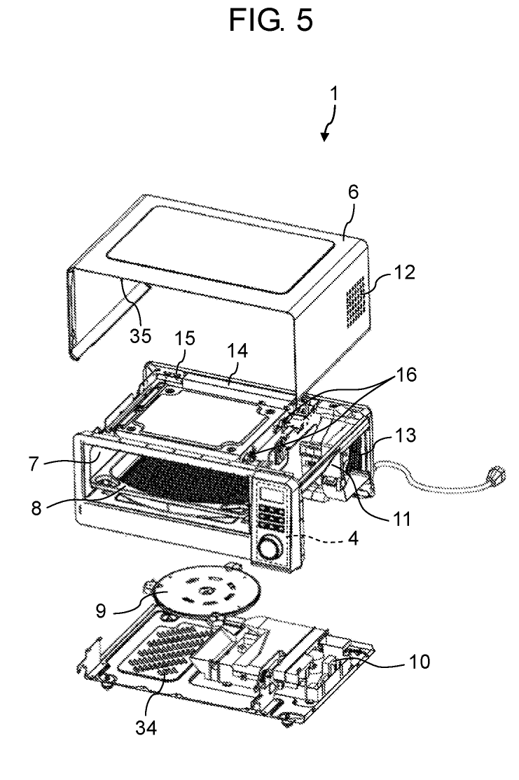

FIG. 5 is an exploded perspective view of main body 1 of the induction heating cooker according to Embodiment 1, illustrating the state where door 2 is removed. As illustrated in FIG. 5, a heating coil which is lower heating unit (induction heating unit) 9 is provided below the bottom surface of heating chamber 7, and grill tray 8 placed inside heating chamber 7 is heated by induction of the heating coil. Control unit 10 which drives and controls lower heating unit 9 is provided at an elevation lower than lower heating unit 9, on the bottom side of main body 1, in a lower area on the back side of setting unit 4. Control unit 10 includes an inverter circuit board, a power supply circuit board, and the like which supply high-frequency current to the heating coil which is lower heating unit 9; thus, a plurality of heat generation components are arranged.

The induction heating cooker according to Embodiment 1 includes: an interior chamber temperature sensor which detects the temperature inside heating chamber 7; and a grill tray temperature sensor which detects the temperature of grill tray 8. The interior chamber temperature sensor is capable of using, for example, a temperature detecting means such as a thermistor and is used to control the interior chamber temperature such that the interior chamber temperature matches the cooking temperature set by setting unit 4. The grill tray temperature sensor is capable of using, for example, a temperature detecting means such as an infrared sensor or a thermistor and is used in the control for determining abnormality and stopping a heating operation, for example, when the temperature of grill tray 8 exceeds a preset temperature.

In the interior space of main body 1, sirocco-type cooling fan 11 is provided in a rear part of the area on the back side of setting unit 4. The axial direction of a rotary shaft of cooling fan 11 is parallel to the lateral direction (horizontal direction) of heating chamber 7; air is drawn through side air inlet 12 formed on a main body side surface (in Embodiment 1, in a rear area of a right-hand side surface) and back air inlet 13 formed on a main body back surface (in Embodiment 1, in a right-hand area of the back surface). Each of air inlets 12 and 13 is made up of a plurality of small openings. Note that guides for defining an intake direction may be provided on the openings of air inlets 12 and 13.

As will be described later, an airflow formed by cooling fan 11 passes through a vent channel formed by a duct having a plurality of air intakes, efficiently cools a high-heat generation region in the induction heating cooker according to Embodiment 1, and is discharged out of the device.

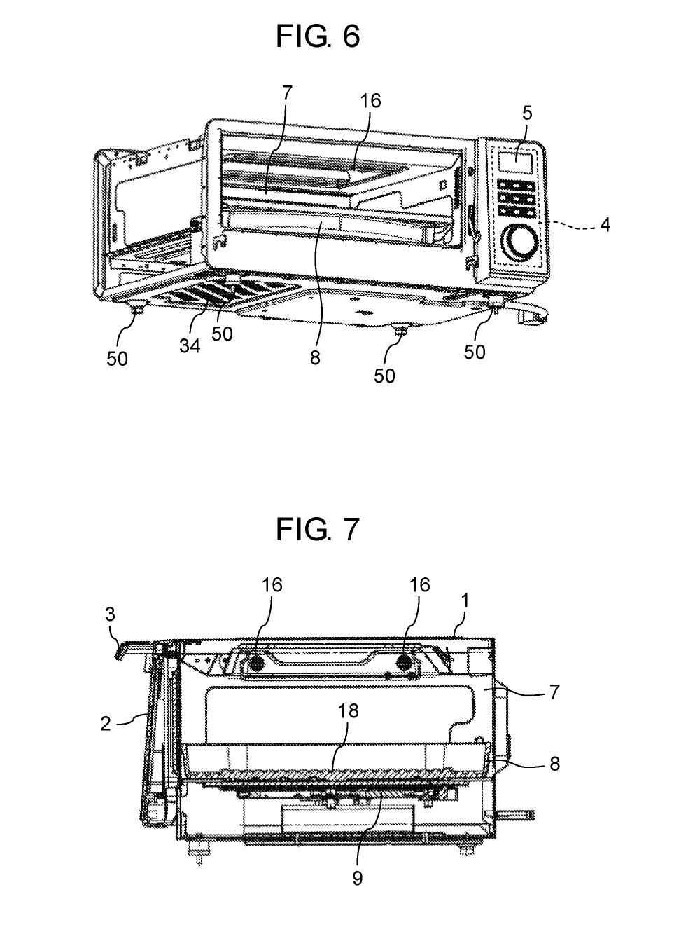

FIG. 6 illustrates main body 1 of the induction heating cooker with main body cover 6 removed when the front of main body 1 is viewed from below, illustrating the interior of heating chamber 7 in which grill tray 8 is housed. As illustrated in FIG. 6, upper heating unit (radiation heating unit) 16, for example, a glass tube heater, is provided on the top of heating chamber 7. The interior of heating chamber 7 is heated with radiation heat from upper heating unit 16. In Embodiment 1, two rod-like, horizontally-extending glass tube heaters are arranged in parallel as upper heating unit 16.

FIG. 7 is a cross-sectional view of the induction heating cooker according to Embodiment 1 when viewed from the side, illustrating the state where grill tray 8 is housed inside heating chamber 7 with door 2 closed. As illustrated in FIG. 7, the glass tube heaters serving as upper heating unit 16 are arranged in recesses formed on the ceiling of heating chamber 7. Recessed surfaces of the recesses in which upper heating unit 16 is provided function as a heat reflector for heating chamber 7 and are configured to be able to efficiently radiate heat to cooking surface 18 of grill tray 8 placed inside heating chamber 7. Note that upper heating unit 16 is not limited to the glass tube heater and can be configured using a heater such as a sheathed heater.

Furthermore, in the induction heating cooker according to Embodiment 1, a sealing means, for example, a heat-resistant elastic body such as silicon rubber, is provided in a position corresponding to an outer peripheral portion of the front opening of heating chamber 7 so that when door 2 closes the front opening, the interior of heating chamber 7 is practically sealed. Note that the phrase “the interior of heating chamber 7 is practically sealed” means the state where water inside heating chamber 7 is inhibited from flowing out of the heating chamber. The sealing means may be provided on the main body side so as to surround the front opening of heating chamber 7 of main body 1 or may be provided on the door side, in a position that corresponds to the area surrounding the front opening of heating chamber 7. Note that the sealing means is preferably provided in a position that corresponds to the area surrounding the front opening of heating chamber 7 and is at least at an elevation higher than grill tray 8 housed in heating chamber 7.

As mentioned earlier, in the induction heating cooker according to Embodiment 1, the heating space of heating chamber 7 is formed short in height compared to the width and depth (size) of the bottom surface thereof, for example, measuring 350 mm (wide)×330 mm (deep)×110 mm (high), and thus a food item placed on cooking surface 18 of grill tray 8 can be efficiently heated at high temperature with the radiation heat from upper heating unit 16. Furthermore, in the induction heating cooker according to Embodiment 1, heating chamber 7 is formed short in height compared to the width and depth (size) of the bottom surface thereof, and the amount of air circulating between the heating space of heating chamber 7 and the outside of the cooker can be limited to a small amount. Therefore, in the induction heating cooker according to Embodiment 1, heating chamber 7 is configured to be substantially sealed space, enabling, inside heating chamber 7, grill cooking in which a steaming operation using the water content of the food item is added to a grilling operation using radiation heating by upper heating unit 16 and induction heating by lower heating unit 9.

Furthermore, in the induction heating cooker according to Embodiment 1, leg portion 50 projecting downward is provided on the bottom surface of main body 1, as illustrated in FIG. 6. Leg portion 50 supports main body 1 when main body 1 is placed on a table. Furthermore, leg portion 50 provides a gap between main body 1 and the table and thus can suppress the effect heat has on the table.

### [Configuration of Grill Tray]

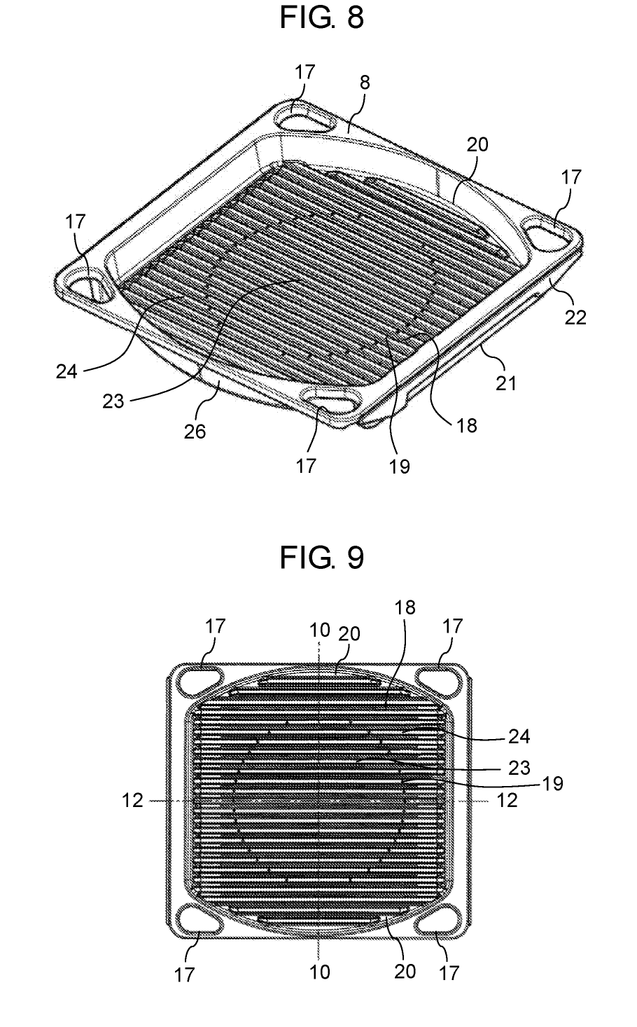

FIG. 8 and FIG. 9 each illustrate grill tray 8 used in the induction heating cooker according to Embodiment 1; FIG. 8 is a perspective view thereof, and FIG. 9 is a plan view thereof. Grill tray 8 is in the shape of a substantial rectangle (including a substantial square) in a plan view and has a flanged edge section which has openings at four corners as grill tray hook portion 17. Grill tray hook portion 17 serves as a part (engaging section) on which a user hooks a kitchen mitten, a pan gripper, or the like when pulling out grill tray 8 after cooking from heating chamber 7. Grill tray hook portion 17, which is an engaging section, may be of any shape including not only the shape of an opening, but also the shape of a recess, a projection, or the like as long as the shape allows a user to pull out grill tray 8 with a finger, etc., hooked thereon.

The main part of grill tray 8 is thermal conductive portion 26 which is made of a high thermal conductive material, for example, a metal such as aluminum or copper. A central region of thermal conductive portion 26 that is surrounded by an edge section thereof is cooking surface 18; cooking surface 18 is formed on an indented surface (bottom surface) of thermal conductive portion 26 that is dented relative to the edge section. Furthermore, a corrugated surface (wavy surface) made up of peaks and valleys extending in one direction is formed on cooking surface 18. In Embodiment 1, the wavy form is defined by peaks and valleys extending in the horizontal direction of heating chamber 7.

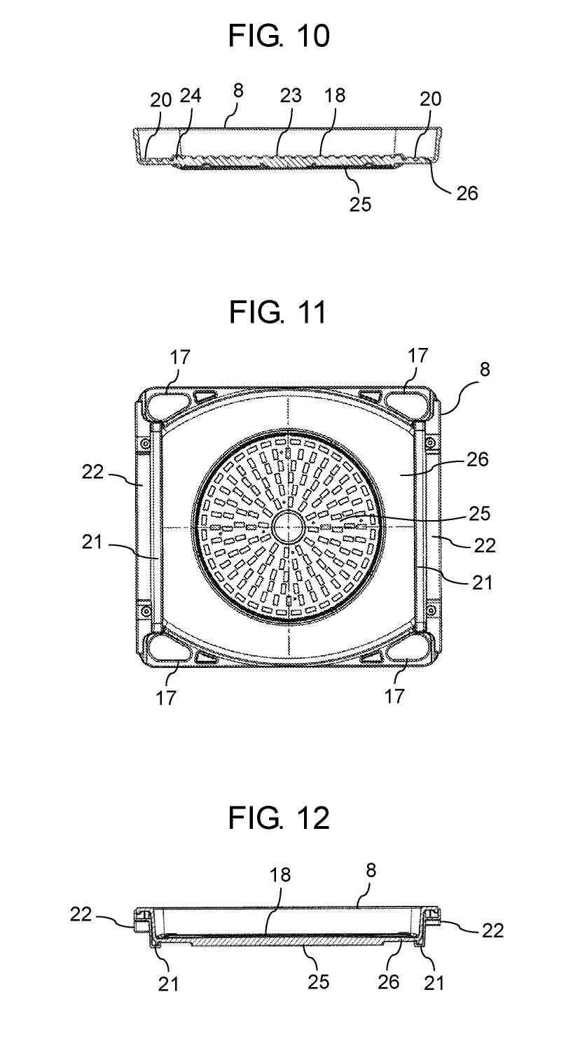

Water storage region 20 is formed on cooking surface 18 of grill tray 8. In grill tray 8 according to Embodiment 1, water storage region 20 is provided in each of the positions forward and rearward of cooking surface 18. FIG. 10 is a cross-sectional view of grill tray 8 in FIG. 9 taken along line 10-10. As shown in FIG. 10, the lowest position of a valley section of water storage region 20 is formed lower in elevation than the lowest position of a valley section of cooking surface 18 other than water storage region 20. Furthermore, in cooking surface 18, water storage region 20 is separated from a region other than water storage region 20 by a peak section so that liquid stored in the valley section of water storage region 20 does not enter the valley section of cooking surface 18 other than water storage region 20.

Note that a peak section is formed also in water storage region 20 as is in cooking surface 18 other than water storage region 20. This is to prevent, when a food item is placed in water storage region 20, the food item from drooping down and touching water or the like in water storage region 20.

As mentioned above, in Embodiment 1, since water storage region 20 is formed on cooking surface 18 of grill tray 8, the effect of steaming a food item can be produced using water coming from the food item and water stored in water storage region 20 during cooking with heat. Furthermore, as a result of configuring heating chamber 7 such that the interior thereof is practically sealed, the water is inhibited from flowing out of heating chamber 7, and thus the food item can be efficiently steamed. Thus, the induction heating cooker according to Embodiment 1 is capable of grill cooking while maintaining the water content of a food item itself.

FIG. 11 is a bottom view of grill tray 8. When grill tray 8 is disposed in a predetermined position (cooking position) inside heating chamber 7, the back surface of grill tray 8 is reliably and properly opposite the heating coil which is lower heating unit 9 disposed under the bottom surface of heating chamber 7 (refer to FIG. 7).

Induction heating body 25 is fixed or attached to thermal conductive portion 26 on the back surface of grill tray 8, in a region opposite lower heating unit 9 (heating coil) when grill tray 8 is in the cooking position. Note that induction heating body 25 is a disc-shaped magnetic body formed using a material having high magnetic permeability such as iron or stainless steel. With such a configuration, grill tray 8 is a small load for an inverter circuit and lower heating unit 9, serving as a load capable of efficient induction heating. Induction heating body 25 is integrally fixed or attached to thermal conductive portion 26 formed of a high thermal conductive material, for example, aluminum or copper, by insert molding, riveting using rivets having recesses and projections, screw fastening, welding, or the like.

Grill tray 8 configured as described above includes, in a region opposite lower heating unit 9, induction heating body 25 which is efficiently heated by induction; this induction heating body 25 is fixed or attached to thermal conductive portion 26 formed of a high thermal conductive material. Therefore, grill tray 8 is efficiently heated by induction by lower heating unit 9 (heating coil) as an item to be heated and is placed in a high temperature state. Thus, a food item which is an item to be heated placed on grill tray 8 is cooked by induction heating via grill tray 8.

FIG. 12 is a cross-sectional view obtained by cutting off grill tray 8 in FIG. 9 along line 12-12 which corresponds to the position of the valley section of cooking surface 18. As illustrated in FIG. 12, induction heating body 25 provided on the back surface of grill tray 8 is formed having a flat back surface, and the back surface of grill tray 8 in the cooking position is in close contact with the bottom surface of heating chamber 7 in such a way that induction heating body 25 is opposite lower heating unit 9 (heating coil). In this cooking position, a projecting end of support portion 21 serving as a foot of grill tray 8, which will be described later, is disposed inside recess 7a (refer to FIG. 4) formed on the bottom surface of heating chamber 7.

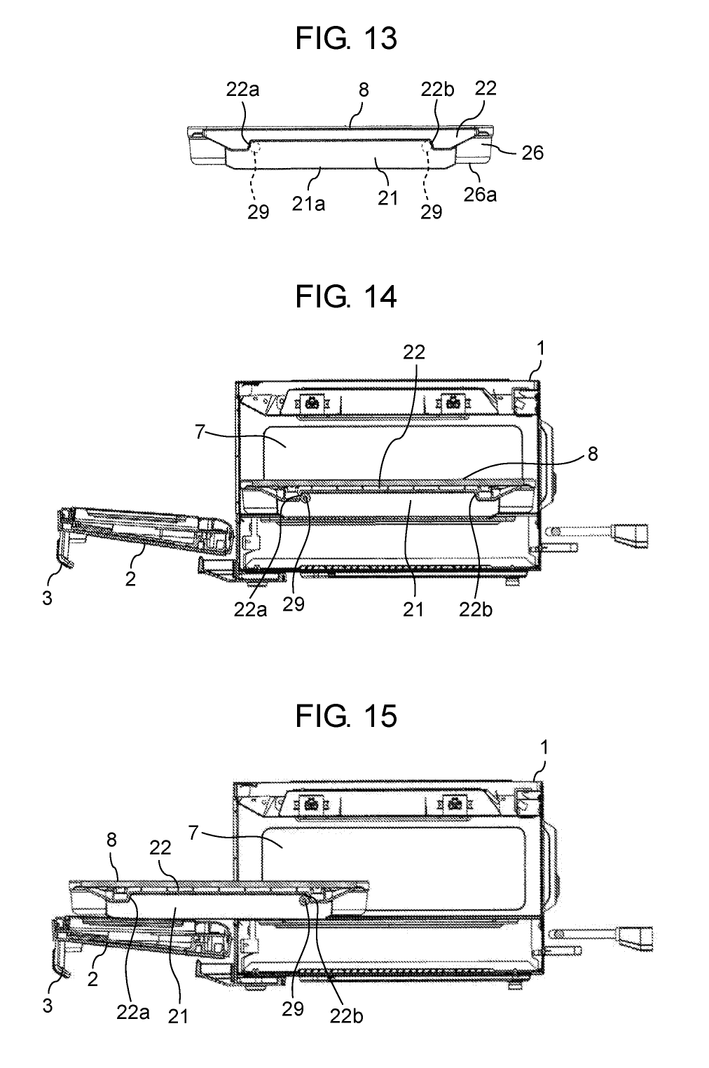

FIG. 13 is a side view illustrating a side surface of grill tray 8 that extends in the front-and-back direction, illustrating support portion 21 and abutment portion 22 which are provided on either side of grill tray 8 and each formed of a heat-resistant resin material. Support portions 21 and abutment portions 22 are fixed or attached to thermal conductive portion 26 which is the main body of grill tray 8 by a fixing or attaching means, for example, screw fastening, welding, or inserting. Support portions 21 and abutment portions 22 located on the both sides of grill tray 8 have substantially the same shapes.

As illustrated in FIG. 13, support portions 21 project downward from lower surface 26a which is in the lowest position in thermal conductive portion 26 serving as the main body of grill tray 8. Lower surface 21a of support portion 21 extends in the front-and-back direction of heating chamber 7 in which support portion 21 is housed and is configured into a flat surface. As mentioned above, support portions 21 are provided on the both sides of grill tray 8; thus, when grill tray 8 taken out of heating chamber 7 is placed on a table, for example, a cooking table, the projecting ends of support portions 21 serve as feet of grill tray 8. As a result, lower surface 26a of thermal conductive portion 26 of grill tray 8 is located a predetermined distance away from a placement surface of the table, and thus a predetermined space is formed between thermal conductive portion 26 of grill tray 8 and the placement surface of the table.

As illustrated in FIG. 4, the bottom surface of heating chamber 7 includes, on both sides, recesses 7a which are elongated in the front-and-back direction and in which the projecting ends of support portions 21 of grill tray 8 are housed. Furthermore, heating chamber projections 29 are provided on both side wall surfaces of heating chamber 7 (refer to FIG. 4) and are arranged so that abutment portions 22 of grill tray 8 engage heating chamber projections 29 when grill tray 8 is housed in heating chamber 7.

Abutment portion 22 provided on a side surface of grill tray 8 is a part of a positioning mechanism for defining a cooking position in which cooking with heat is conducted with grill tray 8 housed in heating chamber 7 and an intermediate holding position in which approximately a half of grill tray 8 is outside heating chamber 7 as a result of being taken out by a user. As illustrated in the side view of grill tray 8 in FIG. 13, abutment portion 22 has an indented shape such that the lower end of a central section thereof is dented upward. In indented abutment portion 22, a rising portion on the front side is first abutment section 22a and a rising portion on the back side is second abutment section 22b.

Heating chamber projections 29 (refer to FIG. 4) are formed on both side surface walls of heating chamber 7; heating chamber projections 29 are a part of a positioning mechanism which engages indented abutment portion 22 when grill tray 8 is in the process of being housed into heating chamber 7. When grill tray 8 is housed in heating chamber 7 and present in the cooking position, heating chamber projections 29 are in abutment with first abutment sections 22a, and thus grill tray 8 locks with heating chamber projections 29. At this time, the projecting ends of support portions 21 serving as the feet of grill tray 8 are inserted into recesses 7a (refer to FIG. 4) of the bottom surface of heating chamber 7.

FIG. 14 is a cross-sectional view illustrating, from the side, the state where grill tray 8 is placed in the cooking position inside heating chamber 7, as illustrated in FIG. 2 described earlier. FIG. 15 is a cross-sectional view illustrating, from the side, the state where grill tray 8 is placed in the intermediate holding position as a result of being pulled out of heating chamber 7, as illustrated in FIG. 3 described earlier.

When pulling out grill tray 8 in the cooking position illustrated in FIG. 14 from heating chamber 7, heating chamber projections 29 slide on the flat surfaces of indented abutment portions 22 and abut and lock with second abutment sections 22b. When grill tray 8 in the cooking position is pulled out from heating chamber 7 as just mentioned, the position in which heating chamber projections 29 abut second abutment sections 22b is referred to as the intermediate holding position (refer to FIG. 15). When grill tray 8 is in the intermediate holding position, support portions 21 of grill tray 8 are supported in contact with the inner wall of door 2 and the bottom surface of heating chamber 7.

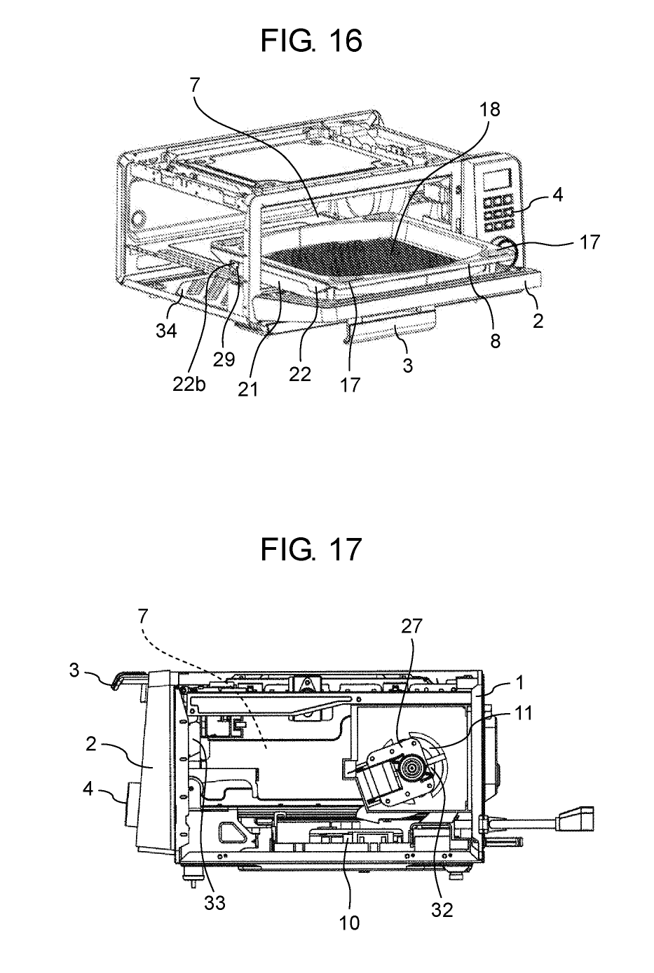

FIG. 16 illustrates the state where second abutment section 22b of abutment portion 22 provided on the left-hand side surface of grill tray 8 in the intermediate holding position locks with heating chamber projection 29 provided on the side wall surface of heating chamber 7. In FIG. 16, a front perspective view at an angle from the upper left corner is shown with main body cover 6, wall surfaces of heating chamber 7, etc., removed to illustrate second abutment section 22b and heating chamber projection 29 that are locking with each other. As mentioned above, abutment portions 22 provided on the both sides of grill tray 8 and heating chamber projections 29 provided on opposite wall surfaces of heating chamber 7 serve as the positioning mechanism according to Embodiment 1.

As mentioned above, when grill tray 8 is in the intermediate holding position, at least a half of grill tray 8 is outside heating chamber 7, and grill tray 8 is supported by a back surface portion of door 2 and a bottom surface portion of heating chamber 7 (refer to FIG. 15). Therefore, a user can easily and safely take grill tray 8 out of heating chamber 7 by holding the indented sections of abutment portions 22 on the both sides of grill tray 8. Note that since grill tray 8 is horizontally symmetrical in shape, the front-and-back direction of grill tray 8 to be inserted into heating chamber 7 is not limited.

In grill tray 8 according to Embodiment 1, since induction heating body 25 which is heated by induction is provided immediately below a central section of cooking surface 18 as mentioned above (refer to FIG. 11), a region of cooking surface 18 that corresponds to induction heating body 25 is heated to a high temperature (for example, 200° C. to 250° C.); then, this region serves as high-temperature cooking region 23 (refer to FIG. 8 and FIG. 9). A region of cooking surface 18 that is outside the region corresponding to induction heating body 25 is made of a high thermal conductive material, but is not a direct heat generation source, and thus serves as low-temperature cooking region 24 (refer to FIG. 8 and FIG. 9) which has a temperature (for example, 150° C. to 200° C.) lower than high-temperature cooking region 23.

Furthermore, as illustrated in FIG. 8 and FIG. 9, boundary mark 19 is displayed on cooking surface 18 so that a user can certainly recognize high-temperature cooking region 23 and low-temperature cooking region 24 of the cooking surface 18. Therefore, upon cooking with heat, a user can place a food item to be cooked at high temperature, for example, meat, fish, etc., in high-temperature cooking region 23 located inward of boundary mark 19, and place a food item to be cooked at low temperature, for example, vegetables, etc., in low-temperature cooking region 24 located outward of boundary mark 19. Thus, in Embodiment 1, the use of grill tray 8 enables desired cooking with heat to be easily and reliably conducted in accordance with a food item and also in accordance with details of how the food item is to be cooked.

A non-sticky overcoat layer made of a fluorocarbon resin or a silicon resin, for example, may be formed on thermal conductive portion 26 which is the main body of grill tray 8 according to Embodiment 1. When such an overcoat layer is formed, dirt such as oil and grease spattered during cooking and remaining debris after cooking can be prevented from sticking to grill tray 8, and even if such dirt sticks thereto, the dirt can be easily wiped out. Furthermore, thermal conductive portion 26 of grill tray 8 may be configured to have hydrophilic properties by blending a silane compound with a fluorine or silicon-based paint or varnish having high heat resistance or may be configured to have a function exhibiting superhydrophilic properties (the angle of contact with water is 10° or less) by blending, for example, a titanium dioxide which is a photocatalyst raw material.

Furthermore, grill tray 8 may include a coating layer which has a self-cleaning function of automatic cleaning by dissolving the oil and grease spattered during cooking through heating during cooking. Examples of a method for providing the coating layer with the self-cleaning function may include a method of blending the coating layer with a manganese-oxide-based catalyst species which promotes an oxidative degradation action, for example, and a method of adding, to the coating layer, platinum which exhibits a remarkable effect in the oxidative degradation action at low temperature or palladium which has high activity in a moderate to high temperature range. Furthermore, a method of adding, to the coating layer, cerium which exhibits adsorption, for example, may also be used.

As mentioned above, by using grill tray 8 in the induction heating cooker according to Embodiment 1, it is possible to reliably conduct, in a short time, grill cooking such that a food item, i.e., meat, fish, vegetables, or the like, is grilled to desired doneness. Furthermore, this configuration allows grill tray 8 to be easily taken out of heating chamber 7 and also be easily washed after cooking.

### [Configuration of Vent Channel]

FIG. 17 is a side view of the induction heating cooker according to Embodiment 1 with main body cover 6 removed. As illustrated in FIG. 17, in the induction heating cooker according to Embodiment 1, sirocco-type cooling fan 11 which forms an airflow is provided on the back side of setting unit 4, in a rear area of the side surface of heating chamber 7.

The axial direction of the rotary shaft of cooling fan 11 is parallel to the horizontal direction of heating chamber 7; air is drawn through side air inlet 12 formed on the main body side surface (in the rear area of the right-hand side surface) and back air inlet 13 formed on the main body back surface (in the right-hand area of the back surface) (refer to FIG. 5), and the air is suctioned into an inlet of cooling fan 11. The airflow formed by cooling fan 11 passes through the vent channel formed downstream of cooling fan 11 by a duct having a plurality of air intakes, efficiently cools the high-heat generation region in the induction heating cooker according to Embodiment 1, and is discharged.

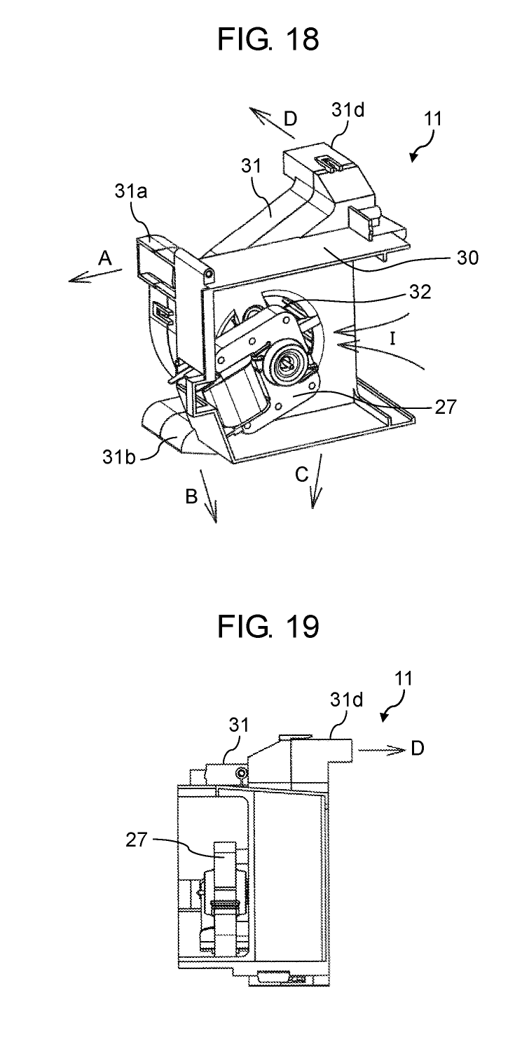

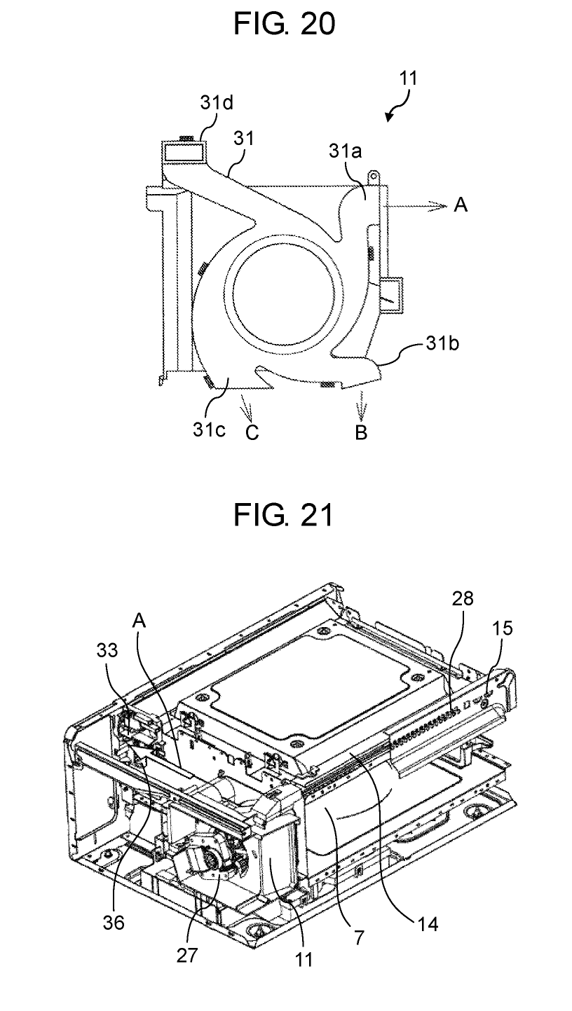

FIG. 18 is a perspective view illustrating a configuration of sirocco-type cooling fan 11. FIG. 18 is a front perspective view of cooling fan 11 viewed at an angle from the upper right corner, mainly illustrating the right-hand side surface thereof. FIG. 19 is a back view of cooling fan 11, and FIG. 20 is a left-hand side view of cooling fan 11. Cooling fan 11 is formed by attaching an impeller having a large number of cylindrically arranged blades to a rotary shaft of fan motor (for example, AC motor) 27, and is configured to draw air through inlet 32 located around the rotary shaft (refer to FIG. 18).

In cooling fan 11 in the induction heating cooker according to Embodiment 1, as illustrated in FIG. 18, air (I) outside of the device is drawn into inlet 32 located around the center of rotation of the rotary shaft through side air inlet 12 and back air inlet 13 of main body 1 (refer to FIG. 5). Air inlet duct 30 which substantially surrounds three sides (upper, lower, and front sides) is provided around inlet 32 of cooling fan 11 (refer to FIG. 18) so that the air (I) outside of the device that has been drawn through side air inlet 12 and back air inlet 13 can reliably and smoothly flow into inlet 32.

As illustrated in FIG. 18 to FIG. 20, cooling fan 11 according to Embodiment 1 includes air intake duct 31 including four air intakes 31a, 31b, 31c, and 31d on outer peripheral portions. Air intake duct 31 forms, around cooling fan 11, a part of each of practically four vent channels that are branched from cooling fan 11.

First airflow A supplied through first air intake 31a is delivered from cooling fan 11 toward the front, flowing in the vent channel directed toward setting unit 4 illustrated in FIG. 17. First airflow A functions to cool, for example, an electric circuit board provided on the back side of setting unit 4, flow on a ceiling surface of heating chamber 7 from the front area to the back area, and discharge the heat of the ceiling surface of heating chamber 7 through back first air outlet 15 (refer to FIG. 5) formed at the top right on the back side of main body 1. Furthermore, first airflow A flows into heating chamber 7 from the front side of heating chamber 7 along the back surface of door 2 by heating chamber inflow guide 33 (refer to FIG. 17) provided on the back side of setting unit 4. Note that the air flowing in from heating chamber inflow guide 33 mainly has a function of removing fog on the back surface of door 2 formed by steam during cooking; the amount of such air as air flowing into heating chamber 7 is small. In the present exemplary embodiment, the airflow guided by heating chamber inflow guide 33 flows into heating chamber 7 through a plurality of small punch holes (inflow ports) 36 (refer to FIG. 21) formed on the side wall surface of heating chamber 7.

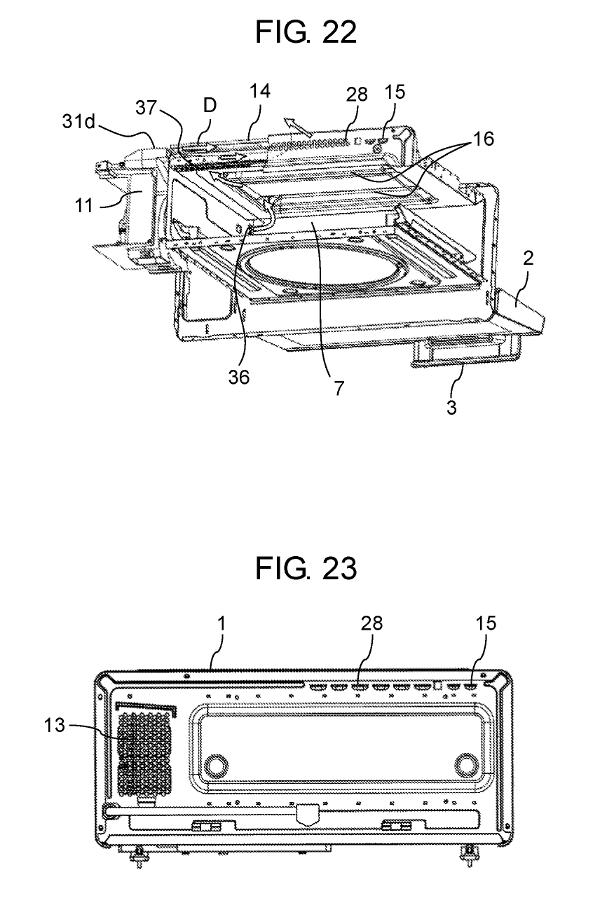

FIG. 21 and FIG. 22 illustrate the vent channel in which first airflow A from cooling fan 11 flows in the induction heating cooker according to Embodiment 1; in each of the figures, parts not needed for description are removed. FIG. 21 is a perspective view of the induction heating cooker when viewed from the top right of the rear area on the back side, mainly illustrating cooling fan 11, heating chamber 7, and the like. FIG. 22 is a perspective view of the induction heating cooker when viewed from the bottom left of the rear area on the back side, illustrating the interior of heating chamber 7 from the back side. In FIG. 22, the bottom surface of heating chamber 7 is illustrated with lower heating unit 9, control unit 10, and the like removed.

As illustrated in FIG. 21, first airflow A from cooling fan 11 is guided by heating chamber inflow guide 33 provided on the back side of setting unit 4 and flows into heating chamber 7 through punch holes (inflow ports) 36 provided in an upper area on the front side of the right-hand side wall surface of heating chamber 7. The airflow that has flown into heating chamber 7 flows along the back surface of door 2 (not illustrated in the drawings) and circulates inside heating chamber 7.

As illustrated in FIG. 22, part of the airflow inside heating chamber 7 passes through opening 37 formed in the upper right area of a back wall of heating chamber 7 and flows into air discharge mixing pipe 14 provided in an upper area on the back side of heating chamber 7. This air discharge mixing pipe 14 is a vent channel in which fourth airflow D to be described later which is directly delivered from cooling fan 11 to the upper area on the back side flows. Therefore, in air discharge mixing pipe 14, a high-temperature airflow from the interior of heating chamber 7 and a low-temperature airflow from cooling fan 11 flow a predetermined distance in parallel and are mixed before being discharged out of the device through back second air outlet 28 formed on the back side of main body 1. Note that a partition plate may be formed in a first half part of the interior of air discharge mixing pipe 14 so that the airflow from the interior of heating chamber 7 and the airflow from cooling fan 11 flow only the predetermined distance in parallel. As a result, the temperature of the air discharged through back second air outlet 28 is significantly lower than the temperature of the high-temperature air directly discharged from heating chamber 7.

FIG. 23 illustrates the back of the induction heating cooker according to Embodiment 1. The back of main body 1 illustrated in FIG. 23 includes back air inlet 13 on the side of the right-hand side surface (on the left-hand side in FIG. 23) near cooling fan 11, which is illustrated in FIG. 22, and back first air outlet 15 on the side of the left-hand side surface (on the right-hand side in FIG. 23). Furthermore, back second air outlet 28 is formed in an upper right area on the back of main body 1, mixes fourth airflow D from cooling fan 11 and the airflow from heating chamber 7 illustrated in FIG. 22, and discharges the mixed airflows. In other words, fourth airflow D is directly led from cooling fan 11 to back second air outlet 28.

Note that in Embodiment 1, a temperature detecting means, for example, a thermistor, detects the temperature of air that has been discharged from heating chamber 7 and just passed through opening 37. In other words, only the temperature of air that has been discharged from heating chamber 7 before being mixed with fourth airflow D is detected inside air discharge mixing pipe 14, and the grill cooking is controlled using the detected temperature as the interior chamber temperature.

As illustrated in the left-hand side view of cooling fan 11 in FIG. 20, in the four vent channels formed by air intake duct 31, second airflow B supplied through second air intake 31b is delivered downwardly forward (toward the lower front) from cooling fan 11. Second airflow B flows in the vent channel for cooling, for example, control unit 10 including a heat generation component in the inverter circuit or the like provided in the lower area on the back side of setting unit 4. Furthermore, second airflow B that has cooled control unit 10, etc., is then guided to lower heating unit 9 (heating coil), cools lower heating unit 9, and is discharged, for example, through back surface air outlet 34 (refer to FIG. 5) formed on the back surface of main body 1 and side surface air outlet 35 (refer to FIG. 3) formed on the left-hand side surface of main body 1.

Third airflow C (refer to FIG. 20) supplied through third air intake 31c of air intake duct 31 is delivered downwardly backward (toward the back surface in a lower area) from cooling fan 11. Third airflow C flows in the vent channel including a guide which directly guides the airflow to lower heating unit 9 (heating coil) and cools lower heating unit 9. Third airflow C that has cooled lower heating unit 9 is discharged, for example, through back surface air outlet 34 (refer to FIG. 5) formed on the back surface of main body 1, together with second airflow B.

As illustrated in FIG. 18, fourth airflow D supplied through fourth air intake 31d of air intake duct 31 is delivered upward on the back side of cooling fan 11, flowing in air discharge mixing pipe 14 (refer to FIG. 21 and FIG. 22) provided along an upper area on the back side of heating chamber 7. As mentioned earlier, air discharge mixing pipe 14 is configured such that part of first airflow A that has flowed through heating chamber 7 is delivered through opening 37 formed on the back-side wall surface of heating chamber 7.

As mentioned above, fourth airflow D from cooling fan 11 and the airflow from heating chamber 7 are mixed and discharged through back second air outlet 28 formed on the back surface of main body 1, and thus the air discharged on the back side of main body 1 has a low temperature. Therefore, in the case of the induction heating cooker according to Embodiment 1, even when the induction heating cooker is placed on a cooking table and there are people around the induction heating cooker, for example, the induction heating cooker is a cooking device with high safety because the temperature of air discharged from the induction heating cooker is kept low.

As described above, the induction heating cooker according to Embodiment 1 is configured to be able to easily conduct cooking with heat in which a food item is grilled to desired doneness, and has a configuration such that, for example, the induction heating cooker can be placed in a desired position on a cooking table and conduct grill cooking; cooking with heat is possible at locations desired by users.

Furthermore, the induction heating cooker according to Embodiment 1 is configured such that the grill tray housed in the heating chamber is efficiently heated to a high temperature by induction heating, and in addition, is heated to a high temperature by radiation heating from above in the heating chamber, thus allowing a food item such as meat, fish, vegetables, or the like to be heated at a desired temperature, for example. Furthermore, in the induction heating cooker according to Embodiment 1, since the induction heating is used, the rise to a preset temperature is quick, and thus cooking time can be reduced, allowing for efficient cooking with heat.

Furthermore, in the induction heating cooker according to Embodiment 1, the heating chamber has sealing ability and is configured to cook a food item with heat in a reduced heating space, allowing for cooking with heat that is equivalent to cooking with steam while maintaining the water content of the food item itself. Furthermore, since the water storage region is formed on the cooking surface of the grill tray, water can be proactively supplied upon cooking with heat; a food item can be cooked with heat in a manner appropriate thereto.

The induction heating cooker according to Embodiment 1 performs the heating operation using the detected interior chamber temperature through the radiation heating from above and the induction heating from below in the heating chamber, and thus is configured such that the cooking temperature, the cooking time, and the like are easily and accurately controlled.

Furthermore, the heating space of the heating chamber in the induction heating cooker according to Embodiment 1 is in the shape of a substantial cuboid, and the bottom surface of the heating chamber has a substantially flat shape, allowing the interior of the heating chamber to be easily cleaned. In the grill cooking, a food item is cooked on the grill tray, and thus most of dirt is located on the grill tray. In the induction heating cooker according to Embodiment 1, the grill tray can be easily taken out of the heating chamber, and since the shape of the grill tray is simple, it is easy to wash the grill tray, and moreover the grill tray according to the present exemplary embodiment is in the shape of an ordinary pan and thus can be washed in a dish washer.

### Embodiment 2

Hereinafter, an induction heating cooker according to Embodiment 2 of the present disclosure will be described with reference to the attached drawings and centering on differences with Embodiment 1. Note that in the description of Embodiment 2, structural elements having the same functions as those according to Embodiment 1 described earlier are assigned the same reference marks, and description thereof will be omitted. The differences of the induction heating cooker according to Embodiment 2 with that according to Embodiment 1 are the structures of a grill tray and a heating chamber in which the grill tray slides and locks. The description of the induction heating cooker according to Embodiment 2 focuses on the grill tray.

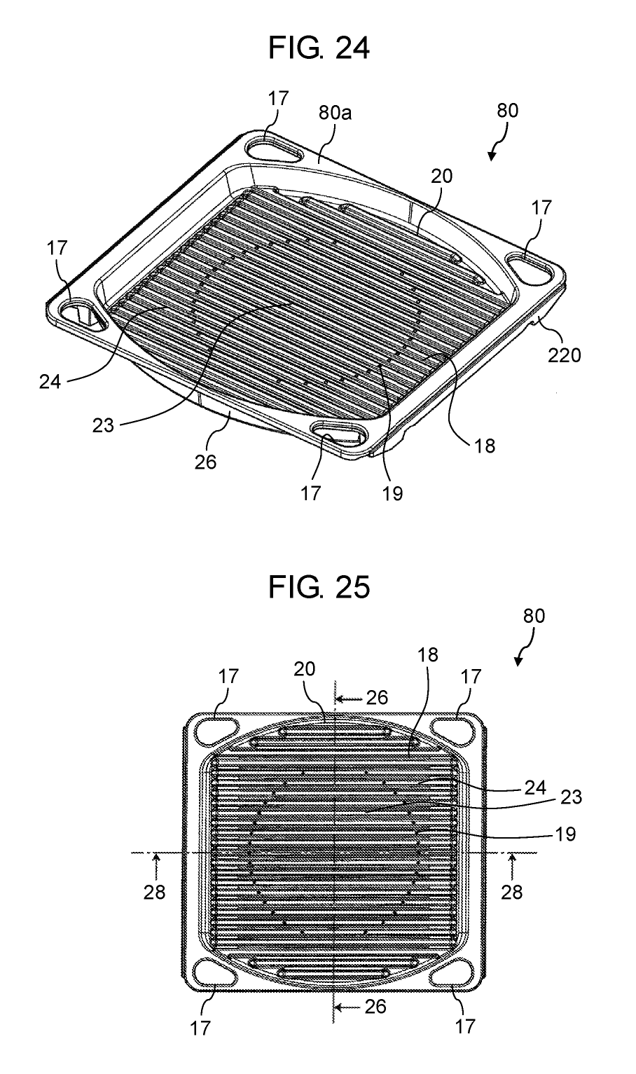

FIG. 24 and FIG. 25 each illustrate grill tray 80 used in the induction heating cooker according to Embodiment 2; FIG. 24 is a perspective view thereof, and FIG. 25 is a plan view thereof. The shape of grill tray 80 is substantially the same in outer diameter dimension (with the shape of a substantial rectangle in a plan view) as grill tray 8 according to Embodiment 1. Grill tray 80 includes flanged portion 80a having a horizontally-extending flanged edge section which includes, at four corners, grill tray hook portion 17 which is openings.

Grill tray 80 according to Embodiment 2 is substantially the same as grill tray 8 according to Embodiment 1 and includes thermal conductive portion 26 which is made of a high thermal conductive material, for example, a metal such as aluminum or copper. A central region of thermal conductive portion 26 that is surrounded by the edge section is cooking surface 18; cooking surface 18 is formed on an indented surface (bottom surface) of thermal conductive portion 26 that is dented relative to the edge section.

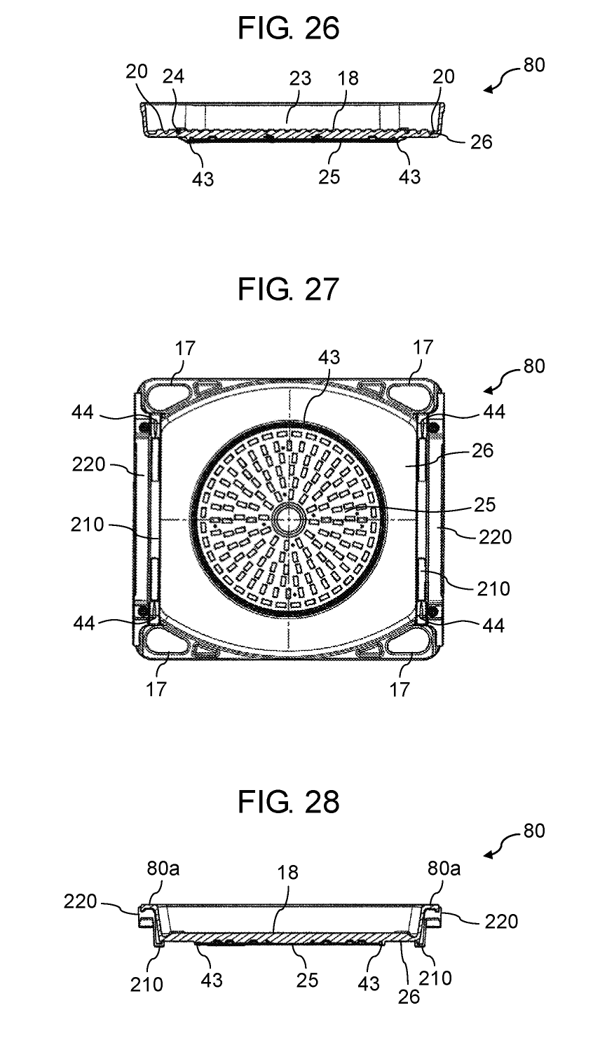

Water storage region 20 is formed on cooking surface 18 of grill tray 80. FIG. 26 is a cross-sectional view of grill tray 80 in FIG. 25 taken along line 26-26. As illustrated in FIG. 26, the lowest position of a valley section of water storage region 20 is formed lower in elevation than the lowest position of a valley section of cooking surface 18 other than water storage region 20. Furthermore, in cooking surface 18, water storage region 20 is separated from a region other than water storage region 20 by a peak section so that liquid stored in the valley section of water storage region 20 does not enter the valley section of cooking surface 18 other than water storage region 20.

FIG. 27 is a bottom view of grill tray 80. When grill tray 80 is disposed in a predetermined position (cooking position) inside heating chamber 7, the back surface of grill tray 80 is reliably opposite the heating coil which is lower heating unit 9 disposed under the bottom surface of heating chamber 7. Induction heating body 25 which is a disc-shaped magnetic body formed using a material having high magnetic permeability such as iron or stainless steel is fixed or attached to thermal conductive portion 26 on the back surface of grill tray 80, in a region opposite lower heating unit 9 (heating coil) when grill tray 80 is in the cooking position. Induction heating body 25 is integrally fixed or attached to thermal conductive portion 26 formed of a high thermal conductive material, for example, aluminum or copper, by insert molding, riveting using rivets having recesses and projections, screw fastening, welding, or the like.

FIG. 28 is a cross-sectional view obtained by cutting off grill tray 80 in FIG. 25 along line 28-28 which corresponds to the position of the valley section of cooking surface 18. As illustrated in FIG. 28, the back surface of grill tray 80 on which induction heating body 25 is provided is formed as a flat surface, and induction heating body 25 on the back surface of grill tray 80 in the cooking position inside heating chamber 7 is located opposite lower heating unit 9 (heating coil).

In the induction heating cooker according to Embodiment 2, annular body 43 which is an annular protruding part is formed on an outer peripheral portion of induction heating body 25 in the shape of a circle on the back surface of grill tray 80. In this annular body 43, three projecting parts are formed at equal intervals. This means that the three projecting parts formed on annular body 43 located on the back surface of grill tray 80 serve as a support part which contacts the bottom surface of heating chamber 7. Therefore, in the cooking position inside heating chamber 7, by being supported at three points, grill tray 80 is placed parallel to the bottom surface of heating chamber 7 with a predetermined distance therebetween. At this time, the predetermined distance between the bottom surface of heating chamber 7 and the back surface of grill tray 80 that corresponds to induction heating body 25 is set to a fixed distance of approximately 0.55 mm, for example, in a central section of the bottom surface of heating chamber 7 so that induction heating body 25 uniformly heated by lower heating unit 9 (heating coil).

Note that when grill tray 80 is placed in the cooking position inside heating chamber 7, the projecting end, which will be described later, of foot portion 210 serving as a foot of grill tray 80 is disposed inside recess 7a (refer to FIG. 4) formed on the bottom surface of heating chamber 7, resulting in a floating state where there is no contact with the bottom surface of heating chamber 7.

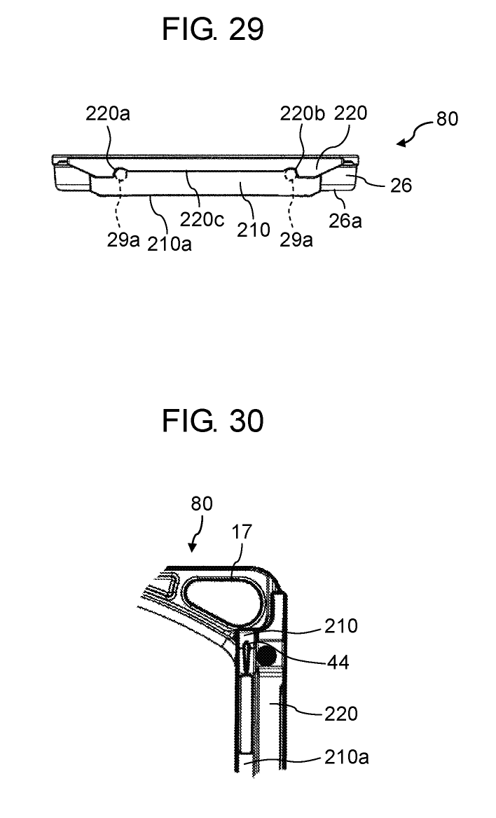

FIG. 29 is a side view illustrating a side surface of grill tray 80 that extends in the front-and-back direction, illustrating foot portion 210 and sliding portion 220 which are provided on either side of grill tray 80. Although the present exemplary embodiment describes an example in which foot portion 210 and sliding portion 220 are integrally formed of a heat-resistant resin material, these portions may be formed as separate parts. Foot portion 210 and sliding portion 220 are firmly fixed or attached to thermal conductive portion 26 which is the main body of grill tray 80 using a fixing or attaching means, for example, screw fastening, welding, or inserting. Foot portions 210 and sliding portions 220 located on the both sides of grill tray 80 have substantially the same shapes.

As illustrated in FIG. 29, foot portion 210 projects at an elevation lower than lower surface 26a which is in the lowest position in thermal conductive portion 26 serving as the main body of grill tray 80. Lower surface 210a of foot portion 210 has an elongated shape extending in the front-and-back direction of heating chamber 7 in which foot portion 210 is housed.

FIG. 30 is an expanded view of a part of grill tray 80 illustrated in the bottom view in FIG. 27, magnifying an end section of lower surface 210a of foot portion 210. As illustrated in FIG. 27 and FIG. 30, support projections 44 projecting downward are formed in front and rear positions on lower surface 210a of foot portion 210. Thus, foot portions 210 including support projections 44 are provided on both sides of grill tray 80; thus, when grill tray 80 taken out of heating chamber 7 is placed on a table, for example, a cooking table, support projections 44 of foot portions 210 serve as practical points of support for grill tray 80. As a result, lower surface 26a of thermal conductive portion 26 of grill tray 80 is located a predetermined distance away from a placement surface of the table, and thus a predetermined space is reliably formed between thermal conductive portion 26 of grill tray 80 and the placement surface of the table (refer to FIG. 29).

As described in Embodiment 1, the bottom surface of heating chamber 7 includes, on both sides, recesses 7a which are elongated in the front-and-back direction and in which the projecting ends of foot portions 210 (refer to FIG. 28) of grill tray 80 are housed. When grill tray 80 is placed in the cooking position inside heating chamber 7, the projecting end of foot portion 210 is disposed inside recess 7a on the bottom surface of heating chamber 7, resulting in a floating state where foot portion 210 is not in contact with the bottom surface of heating chamber 7. Thus, when grill tray 80 is placed in the cooking position inside heating chamber 7, grill tray 80 is supported above the bottom surface of heating chamber 7 by the projecting parts of annular body 43, and thus a part of the back surface of grill tray 80 on which induction heating body 25 is located a predetermined distance away from the bottom surface of heating chamber 7.

Note that the shape of lower surface 210a of foot portion 210 attached to grill tray 80 is somewhat curved in the front-and-back direction with a depressed central section (refer to FIG. 29). This is because when grill tray 80 with lower surface 210a of foot portion 210 projecting downward is placed on a table, grill tray 80 may become wobbly and unstable; depressing lower surface 210a upward resulting in point contact at foot portion 210, which allows grill tray 80 to be stably placed on a table.

As illustrated in FIG. 29, along with foot portion 210, sliding portion 220 is formed on the side surface of grill tray 80. During movement of grill tray 80 being housed into heating chamber 7 and during movement of grill tray 80 being pulled out from the interior of heating chamber 7, this sliding portion 220 functions to support grill tray 80 during the movement of grill tray 80 by contacting heating chamber projections 29 (refer to FIG. 4) provided on both side surface walls of heating chamber 7.

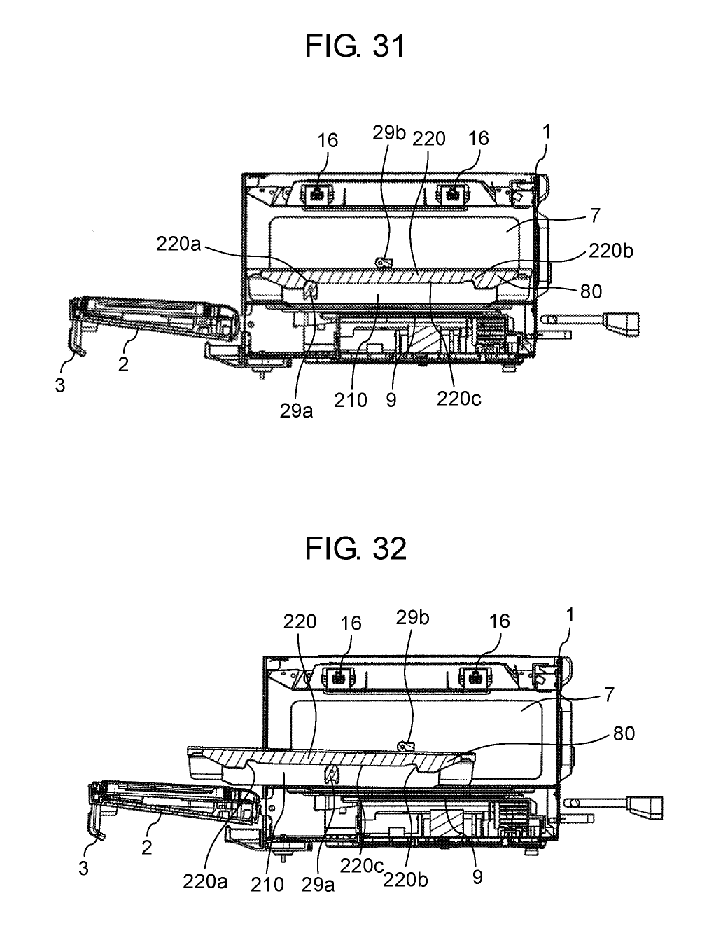

Heating chamber projections 29 provided on the side surface walls of heating chamber 7 are co-located on opposite side surface walls of heating chamber 7 in such a way as to face each other. Each of heating chamber projections 29 according to Embodiment 2 includes: sliding projection 29a provided in a front area on the bottom side of the side surface wall of heating chamber 7; and attitude-holding projection 29b (refer to FIG. 31 to FIG. 33) provided at the approximate center of the side surface wall. The positions of sliding projection 29a and attitude-holding projection 29b are determined according to the shape of grill tray 80 so that grill tray 80 assumes a desired postural position during movement. Note that in Embodiment 2, sliding projection 29a is formed of metal, for example, aluminum, and attitude-holding projection 29b is formed of a resin material. Preferably, at least sliding projection 29a is made of metal because sliding projection 29a slidably supports grill tray 80.

Heating chamber projections 29 (29a, 29b) which are attitude control units provided on the opposite side surface walls of heating chamber 7 and sliding portions 220 on the side surfaces of grill tray 80 are not only a positioning mechanism for defining a cooking position in which cooking with heat is conducted with grill tray 80 housed in heating chamber 7 and an intermediate holding position in which approximately a half of grill tray 80 is outside heating chamber 7 as result of being taken out by a user, but also have the functions of an attitude control mechanism which works when grill tray 80 is being housed into heating chamber 7 and when grill tray 80 is being pulled out from heating chamber 7.

As illustrated in the side view of grill tray 80 in FIG. 29, sliding portion 220 has a generally substantially indented shape such that the lower end thereof is dented upward. In the section of sliding portion 220 that has the generally substantially indented shape, one edge section, for example, a front-side edge section, is first engaging section 220a which is further depressed upward, and a back-side edge section is second engaging section 220b which is likewise further depressed upward. Note that grill tray 80 can be used in either front or back direction; the front and the back of grill tray 80 have the same shape, but grill tray 80 illustrated in FIG. 29 is described assuming that the left-hand side in the sheet of the drawing of FIG. 29 is defined as the front side. Therefore, first engaging section 220a and second engaging section 220b of sliding portion 220 have the same shape and are co-located on grill tray 80.

FIG. 31 is a cross-sectional side view illustrating the state where grill tray 80 is placed in the cooking position inside heating chamber 7. When grill tray 80 illustrated in FIG. 31 is housed in heating chamber 7 and located in the cooking position, sliding projection 29a is inserted and locked into first engaging section 220a (the front-side engaging section of grill tray 80) which is a recess; grill tray 80 is positioned by sliding projection 29a. At this time, the projecting end of foot portion 210 serving as the foot of grill tray 80 is within recess 7a (refer to FIG. 4) on the bottom surface of heating chamber 7, that is, in the floating state. Furthermore, at this time, annular body 43 (refer to FIG. 27) formed on the bottom surface of grill tray 80 includes at least three projecting parts in contact with the bottom surface of heating chamber 7, resulting in the state where grill tray 80 is maintained a predetermined distance away from the bottom surface of heating chamber 7.

When grill tray 80 in the cooking position is being pulled out from heating chamber 7, sliding projection 29a comes out of the recess of first engaging section 220a and slides on sliding edge section 220c extending to second engaging section 220b. Thus, when grill tray 80 in the cooking position is being pulled out from heating chamber 7, grill tray 80 moves forward with the front thereof lifted.

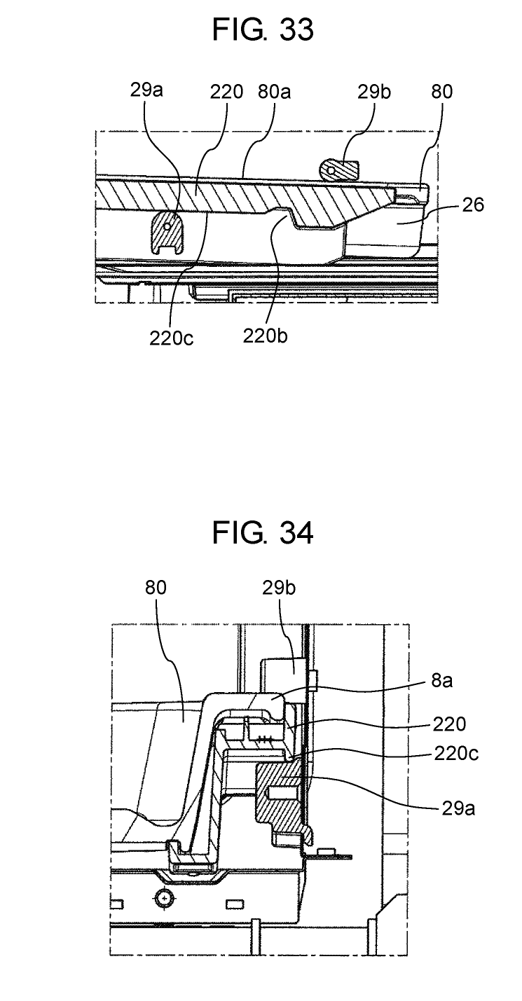

FIG. 32 is a cross-sectional side view illustrating the state where grill tray 80 is in the process of being pulled out from heating chamber 7. FIG. 33 is an expanded view illustrating grill tray 80 in the process of being pulled out, which is illustrated in FIG. 32, and sliding projection 29a and attitude-holding projection 29b which contact grill tray 80.

As illustrated in FIG. 32 and FIG. 33, sliding projection 29a slides along sliding edge section 220c of sliding portion 220, and attitude-holding projection 29b located at an elevation higher than and backward of the position of sliding projection 29a abuts the upper surface of flanged portion 80a which is the edge section of grill tray 80. This means that when the position of sliding projection 29a is backward of the position of the center of grill tray 80 (the position of the center of sliding portion 220) in the state where grill tray 80 is in the process of being pulled out, force that rotates the front of grill tray 80 downward about sliding projection 29a acts on grill tray 80. Therefore, in the state where grill tray 80 is in the process of being pulled out, attitude-holding projection 29b located backward of sliding projection 29a abuts flanged portion 80a of grill tray 80 to hold the back of grill tray 80. Thus, grill tray 80 slides while maintaining its state of being slightly lifted as a whole by sliding projection 29a.

FIG. 34 is an expanded cross-sectional view obtained by cutting off grill tray 80 in the horizontal direction, illustrating sliding projection 29a which slides on sliding edge section 220c of sliding portion 220 of grill tray 80 in the process of being pulled out, which is illustrated in FIG. 32. As illustrated in FIG. 34, the lower end of sliding edge section 220c of sliding portion 220 is formed such that a cross-section thereof orthogonal to the sliding direction is in the shape of a circular arc or shaped to have a thin lower end. Thus, sliding edge section 220c and sliding projection 29a are in a practically point contact sliding state. As a result, with the configuration according to Embodiment 2, the frictional resistance during sliding of grill tray 80 is reduced so that grill tray 80 can move with a small force.

As mentioned above, sliding projection 29a slides along sliding edge section 220c of sliding portion 220 of grill tray 80 in point contact therewith and is inserted and locked into second engaging section 220b which is a recess located on in a back area of grill tray 80. In this way, grill tray 80 in the cooking position is pulled out from heating chamber 7, and sliding projection 29a is inserted and locked into second engaging section 220b (refer to FIG. 33) which is a recess; this position is referred to as the intermediate holding position.

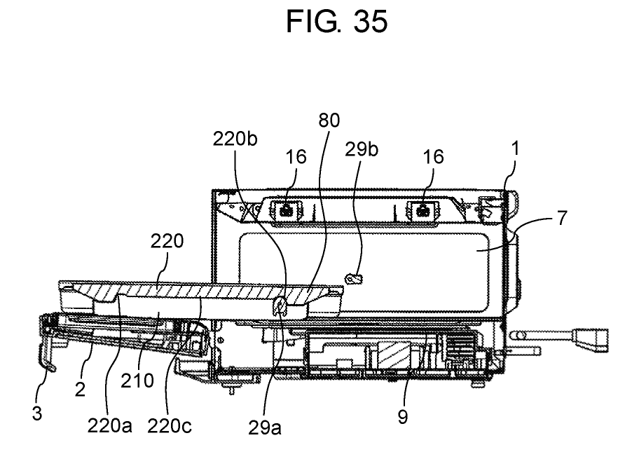

FIG. 35 is a cross-sectional side view illustrating the state where grill tray 80 is placed in the intermediate holding position as a result of being pulled out from heating chamber 7. As illustrated in FIG. 35, when grill tray 80 is in the intermediate holding position, attitude-holding projection 29b is separated from grill tray 80. Therefore, the front of grill tray 80 is rotated downward about sliding projection 29a until the front of foot portion 210 of grill tray 80 contacts the inner wall of door 2 (for example, a glass panel serving as a window for checking the cooking progress inside heating chamber 7); thus, grill tray 80 is supported. Note that in the configuration according to Embodiment 2, the inner wall of door 2 in a fully open state has a surface sloped forward at an upward angle of 2 to 5 degrees up with respect to the horizontal plane.

Note that a sealing member as a seal material is provided between door 2 and the outer peripheral portion of the front opening of heating chamber 7 in the state where heating chamber 7 is substantially sealed with door 2 closed. Therefore, with heating chamber projection 29 which serves as an attitude control unit when grill tray 80 is being housed and when grill tray 80 is being pulled out, the sealing member does not contact grill tray 80.

As mentioned above, sliding portions 220 provided on the both sides of grill tray 80 and heating chamber projections 29 (29a, 29b) provided on the opposite wall surfaces of heating chamber 7 serve as a positioning mechanism and an attitude control mechanism according to Embodiment 2. When grill tray 8 is in the intermediate holding position, at least a half of grill tray 80 is outside heating chamber 7, and grill tray 80 is supported by an inner wall portion of door 2 and a bottom surface portion of heating chamber 7. Therefore, a user can easily and safely take grill tray 80 out of heating chamber 7 by holding the substantially indented sections of sliding portions 220 on the both sides of grill tray 80. Note that since grill tray 80 is horizontally symmetrical in shape, the front-and-back direction of grill tray 80 to be inserted into heating chamber 7 is not limited.

As described in the exemplary embodiments, the induction heating cooker according to the present disclosure is configured to be able to easily conduct grill cooking in which a food item is grilled to desired doneness, and moreover it is possible to provide an induction heating cooker that allows a user to easily conduct desired grill cooking at a desired location.

### INDUSTRIAL APPLICABILITY

As described above, the induction heating cooker according to the present disclosure is configured to enable efficient cooking with heat using at least the induction heating and also be able to easily conduct grill cooking in which a food item is grilled to desired doneness, and moreover has a configuration such that a user can use the induction heating cooker at a desired location; thus, this cooking device is useful.

### REFERENCE MARKS IN THE DRAWINGS

1 main body
2 door
3 door handle
4 setting unit
5 display unit
6 main body cover
7 heating chamber
7a recess
8 grill tray
9 lower heating unit (induction heating unit)
10 control unit
11 cooling fan
16 upper heating unit (radiation heating unit)
17 grill tray hook portion
18 cooking surface
19 boundary mark
20 water storage region
21 support portion (foot portion)
22 abutment portion
23 high-temperature cooking region
24 low-temperature cooking region
25 induction heating body
26 thermal conductive portion
29 heating chamber projection
30 air inlet duct
31 air intake duct
31a first air intake
31b second air intake
31c third air intake
31d fourth air intake
32 inlet
50 leg portion
80 grill tray
210 foot portion
220 sliding portion

1. An induction heating cooker comprising:
a heating chamber in which an item to be heated is housed;
a door which seals an opening through which the item to be heated is inserted into and removed from the heating chamber;
a heating unit including an induction heating unit which heats, by induction, the item to be heated that is housed inside the heating chamber;
a control unit which drives and controls the heating unit; and
a setting unit which sets a heating operation of the heating unit, wherein
the induction heating cooker is configured as being placeable on a table.

2. The induction heating cooker according to claim 1, wherein
the heating unit further includes a radiation heating unit which heats an interior of the heating chamber by radiation.

3. The induction heating cooker according to claim 2, wherein
the heating unit includes the induction heating unit below the heating chamber and the radiation heating unit above the heating chamber.

4. The induction heating cooker according to claim 1, wherein the heating unit is configured to heat a grill tray as an item to be heated, and the heating chamber includes a heating chamber projection which positions the grill tray in a cooking position inside the heating chamber.

5. The induction heating cooker according to claim 4, wherein
when the grill tray is housed in the heating chamber and positioned in the cooking position, a foot portion of the grill tray is located in a recess formed on a bottom surface of the heating chamber and does not contact the bottom surface, and a cooking surface of the grill tray is located in a predetermined position with respect to the heating unit, the foot portion projecting downward, the cooking surface being a surface on which a food item is placed.

6. The induction heating cooker according to claim 4, wherein
the grill tray is configured to be supported on the door in an open state by locking with the heating chamber projection when the grill tray is being pulled out from the heating chamber.

7. A grill tray used in an induction heating cooker which is configured as being placeable on a table and includes:
a heating chamber in which an item to be heated is housed;
a door which seals an opening through which the item to be heated is inserted into and removed from the heating chamber; and
a heating unit including an induction heating unit which heats, by induction, the item to be heated that is housed inside the heating chamber, wherein
the grill tray is formed of a high thermal conductive material and includes a magnetic material in a region opposite the heating unit.

8. The grill tray according to claim 7, wherein
the grill tray includes a water storage region configured to be able to hold water.

9. The grill tray according to claim 7, wherein
a cooking surface of the grill tray includes a boundary mark indicating a region that opposes the heating unit, and a higher-temperature cooking region and a lower-temperature of the cooking surface cooking region are separated by the boundary mark, the cooking surface being a surface on which a food item is placed.

10. The grill tray according to claim 7, further comprising
a foot portion formed of a heat-resistant resin material, wherein
when the grill tray is taken out of the heating chamber and placed on the table, the foot portion serves as a foot that supports the grill tray with a predetermined space above a placement surface of the table.

11. The grill tray according to claim 7, wherein
a cooking surface of the grill tray is in the form of waves and coated by a non-sticky resin, the cooking surface being a surface on which a food item is placed.
